(19) United States
(12) Patent Application Publication
(10) Pub. No.: US 2020/0378194 A1
(43) Pub. Date: Dec. 3, 2020

(54) Casing With External Thread and Methods of Manufacture

(71) Applicant: Saudi Arabian Oil Company, Dhahran (SA)

(72) Inventors: Simone Musso, Houston, TX (US); Timothy Eric Moellendick, Houston, TX (US); Guodong Zhan, Dhahran (SA)

(21) Appl. No.: 16/885,427

(22) Filed: May 28, 2020

Related U.S. Application Data
(60) Provisional application No. 62/853,347, filed on May 28, 2019.

(51) Int. Cl. E21B 17/042; F16L 58/04

(52) U.S. Cl. CPC E21B 17/042; F16L 58/04

(57) ABSTRACT

A casing for a drilling operation has a body portion having a length, a first end and a second end, an outer diameter, an inner diameter, and a central axis that is common to the outer diameter and the inner diameter, and an external thread formed on the outer diameter of the body portion, wherein the external thread starts at a first predetermined distance from the first end and ends at a second predetermined distance from the second end. The external thread includes a spiral groove or a helical thread formed on the outer diameter of the body portion. The casing includes a coating at least partially encapsulating the external thread, wherein the coating includes at least one material selected from the group consisting of polycrystalline diamond particles, diamond like carbon (DLC), tungsten carbide, boron nitride, silicon carbide, silicon nitride, and combinations thereof.

### CROSS-REFERENCE TO RELATED APPLICATIONS

This application claims priority of U.S. Provisional Application No. 62/853,347, titled “CASING WITH EXTERNAL THREAD AND METHODS OF MANUFACTURE,” which was filed on May 28, 2019, the entire contents of which are incorporated herein by reference.

### TECHNICAL FIELD

Example embodiments relate to drilling operations in the oil and gas industry. More specifically, example embodiments relate to a casing for use in drilling operations, and a method of manufacture thereof.

### BACKGROUND

A casing string is an assembled length of steel pipe configured to suit a specific wellbore. The sections of pipe are connected and lowered into a wellbore, then cemented in place. The pipe joints are typically approximately 40 ft (12 m) in length, male threaded on each end and connected with short lengths of double-female threaded pipe called couplings. Long casing strings may require higher strength materials on the upper portion of the string to withstand the string load. Lower portions of the string may be assembled with casing of a greater wall thickness to withstand the extreme pressures likely at depth.

A casing is run to protect or isolate formations adjacent to the wellbore. Some of the common reasons for running casing in a well include protecting fresh-water aquifers (surface casing), providing strength for installation of wellhead equipment, including blow out preventers (BOPs), providing pressure integrity so that wellhead equipment, including BOPs, may be closed, sealing off leaky or fractured formations into which drilling fluids are lost, sealing off low-strength formations so that higher strength (and generally higher pressure) formations may be penetrated safely, sealing off high-pressure zones so that lower pressure formations may be drilled with lower drilling fluid densities, sealing off troublesome formations, such as flowing salt, and complying with regulatory requirements (usually related to one of the factors listed supra).

FIG. 1 illustrates two types of bottom hole assemblies (BHAs). A first type of BHA 100 is suitable for a straight or vertical hole, and a second type BHA 120 is suitable for a directional or horizontal hole. The lower portion of the drillstring in a first type of BHA 100 includes (from the bottom up in a vertical well) a bit 102, a bit sub 104, a mud motor 106, stabilizers (not shown), drill collars 108, heavy-weight drillpipes 110, jarring devices (“jars”), and crossovers for various threadforms. The upper portion of the drillstring may include a coiled tubing 112, check valve assembly 114, and a pressure disconnect 116, for example. The second type BHA 120 may include, in addition to those described with respect to BHA 100, an orienting tool 122, a measurement-while-drilling (MWD) or logging-while-drilling (LWD) tool 124 in a nonmagnetic drill collar, and an adjustable bent housing 126. The bottomhole assembles 100, 120 provide force for the bit to break the rock (weight on bit), survive a hostile mechanical environment, and provide the driller with directional control of the well. Oftentimes the assembly includes a mud motor, directional drilling and measuring equipment, measurements-while-drilling tools, logging-while-drilling tools, and other specialized devices.

### SUMMARY

One example embodiment is a casing for a drilling operation. The casing includes a body portion having a length, a first end and a second end, an outer diameter, an inner diameter, and a central axis that is common to the outer diameter and the inner diameter. The casing also has an external thread formed on the outer diameter of the body portion, wherein the external thread starts at a first predetermined distance from the first end and ends at a second predetermined distance from the second end. The external thread includes a spiral groove or a helical thread formed on the outer diameter of the body portion. The external thread is formed at an angle ranging from about 1 degree to 45 degrees. The external thread protrudes from the casing about 0.25 to 2.0 inches. The casing includes a coating at least partially encapsulating the external thread, wherein the coating includes at least one material selected from the group consisting of polycrystalline diamond particles, diamond like carbon (DLC), tungsten carbide, boron nitride, silicon carbide, silicon nitride, and combinations thereof.

The coating is deposited by physical vapor deposition, chemical vapor deposition, plasma spraying, atomic layer deposition, or combinations thereof. The coating further includes nano particles comprising tungsten carbide or diamond. The external thread is formed at least 200 feet behind a drill bit of a bottom hole assembly to which the casing is attached. The casing is suitable for operation in a straight hole or a directional hole. The casing is hydro-formed, spray metal, or carbon fiber reinforced. The external thread can be right handed or left handed, and may include one or more starts.

Another example embodiment is a method of forming a casing for a drilling operation. The method includes providing a body portion having a length, a first end and a second end, an outer diameter, an inner diameter, and a central axis that is common to the outer diameter and the inner diameter. The method also includes forming an external thread on the outer diameter of the body portion, wherein the external thread starts at a first predetermined distance from the first end and ends at a second predetermined distance from the second end. The external thread comprises a spiral groove or a helical thread formed on the outer diameter of the body portion. The method may also include providing a coating that at least partially encapsulates the external thread, wherein the coating comprises at least one material selected from the group consisting of polycrystalline diamond particles, diamond like carbon (DLC), tungsten carbide, boron nitride, silicon carbide, silicon nitride, and combinations thereof. The coating is deposited by physical vapor deposition, chemical vapor deposition, plasma spraying, atomic layer deposition, or combinations thereof. The coating further comprises nano particles comprising tungsten carbide or diamond.

### BRIEF DESCRIPTION OF THE DRAWINGS

The foregoing aspects, features, and advantages of embodiments of the present disclosure will further be appreciated when considered with reference to the following description of embodiments and accompanying drawings. In describing embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

For simplicity and clarity of illustration, the drawing figures illustrate the general manner of construction, and descriptions and details of well-known features and techniques may be omitted to avoid unnecessarily obscuring the discussion of the described embodiments. Additionally, elements in the drawing figures are not necessarily drawn to scale. For example, the dimensions of some of the elements in the figures may be exaggerated relative to other elements to help improve understanding of the various embodiments. Like reference numerals refer to like elements throughout the specification.

FIG. 1 illustrates two configurations of bottom hole assemblies, according to prior art teachings.

FIGS. 2A-2C illustrate schematics of a casing for drilling, according to one or more example embodiments of the disclosure.

FIG. 3 illustrates an example method for manufacturing a casing for drilling, according to one or more example embodiments of the disclosure.

### DETAILED DESCRIPTION

The methods and systems of the present disclosure will now be described more fully hereinafter with reference to the accompanying drawings in which embodiments are shown. The methods and systems of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

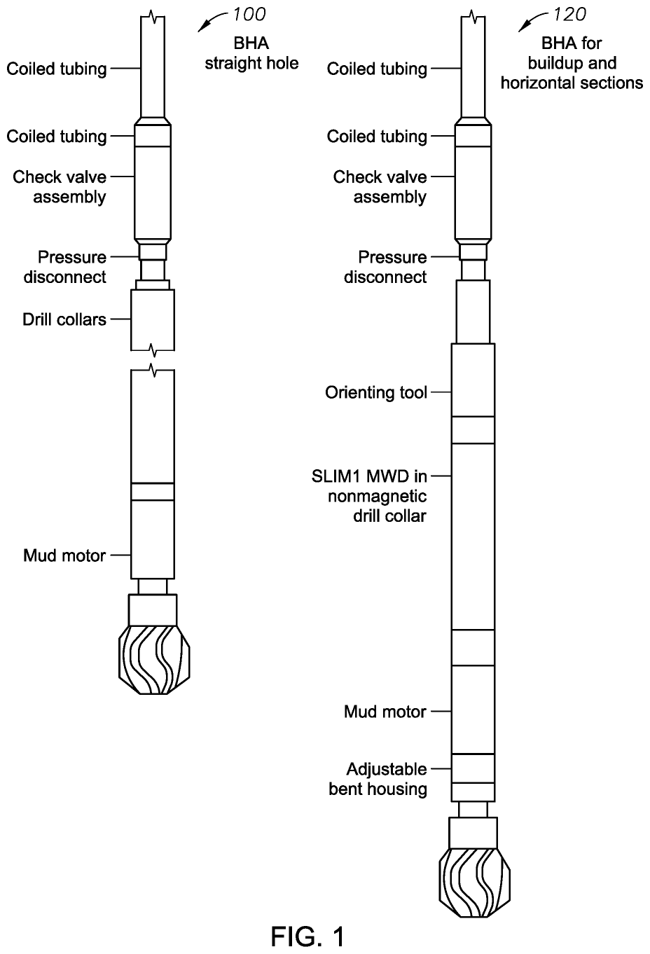

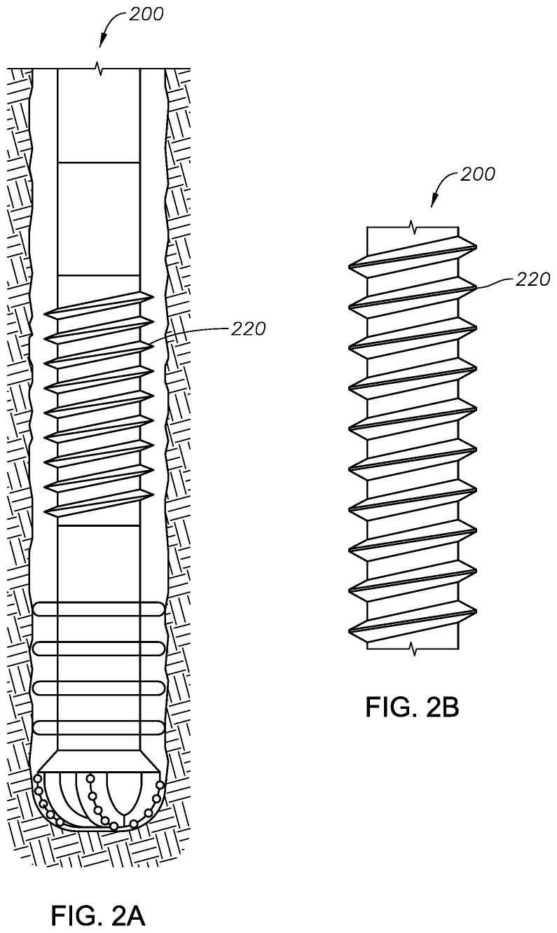

Turning now to the figures, FIGS. 2A-2C illustrate schematics of a casing 200 for a drilling operation, according to one or more example embodiments of the disclosure. As illustrated in FIG. 2A, the casing 200 can be a part of the bottom hole assembly 110 or 120, illustrated in FIG. 1. In one example embodiment, the casing 200 may be installed at least 200 feet behind a drill bit 202 of a bottom hole assembly 110, 120 to which the casing is attached. The casing 200 may be suitable for operation in a straight hole or a directional hole.

FIG. 2B illustrates a close-up view of the casing 200, according to one embodiment of the disclosure. The casing 200 includes a body portion 204 having a length 206, a first end 208, and a second end 210. FIG. 2C illustrates a further close-up view of a portion of the casing 200. As illustrated in this figure, the casing 200 includes an outer diameter d₂, an inner diameter d₃, and a central axis 210 that is common to the outer diameter and the inner diameter. The casing 200 also has an external thread 220 formed on the outer diameter d₂ of the body portion 204. As illustrated in FIG. 2B, the external thread 220 starts at a first predetermined distance from the first end 208 and ends at a second predetermined distance from the second end 210.

In one example embodiment, the external thread 220 includes a spiral groove or a helical thread formed on the outer diameter d₂ of the body portion 204. In one example embodiment, the external thread 220 is formed at an angle ranging from about 1 degree to 45 degrees. In one example embodiment, the external thread 220 protrudes from the outer diameter d₂ of the casing about 0.25 to 2.0 inches.

In one example embodiment, the external thread 220 is formed at least 200 feet behind a drill bit 202 of the bottom hole assembly to which the casing is attached. However, in some cases the distance between the drill bit 202 and the casing 200 may be greater or lesser than 200 feet, depending on the design the bottom hole assembly. As it may be apparent to one of skill in the art, the casing 200 is suitable for operation in a straight hole or a directional hole. In one example embodiment, the casing 200 may be hydro-formed, spray metal, or carbon fiber reinforced.

Hydroforming is a cost-effective way of shaping ductile metals such as aluminium, brass, low alloy steel, and stainless steel into lightweight, structurally stiff and strong pieces. Complex shapes are made possible by hydroforming to produce stronger, lighter, and more rigid unibody structures. Hydroforming is a specialized type of die forming that uses a high pressure hydraulic fluid to press room temperature working material into a die. To hydroform aluminium, a hollow tube of aluminium is placed inside a negative mold that has the shape of the desired result. High pressure hydraulic pumps then inject fluid at very high pressure inside the aluminium tube which causes it to expand until it matches the mold. The hydroformed aluminium is then removed from the mold. Hydroforming allows complex shapes with concavities to be formed, which would be difficult or impossible with standard solid die stamping. Hydroformed parts can often be made with a higher stiffness-to-weight ratio and at a lower per unit cost than traditional stamped or stamped and welded parts. Virtually all metals capable of cold forming can be hydroformed, including aluminium, brass, carbon and stainless steel, copper, and high strength alloys.

In one embodiment, the casing 200 can be formed of a carbon fiber reinforced composite. The composite is an extremely strong and light fiber-reinforced plastic which contains carbon fibers. The binding polymer is often a thermoset resin such as epoxy, but other thermoset or thermoplastic polymers, such as polyester, vinyl ester, or nylon, are sometimes used. The composite material may contain aramid (e.g. Kevlar, Twaron), ultra-high-molecular-weight polyethylene (UHMWPE), aluminium, or glass fibers in addition to carbon fibers. The properties of the final composite product can also be affected by the type of additives introduced to the binding matrix (resin). The most common additive is silica, but other additives such as rubber and carbon nanotubes can be used. The material is also referred to as graphite-reinforced polymer or graphite fiber-reinforced polymer (GFRP is less common, as it clashes with glass-(fiber)-reinforced polymer).

In one example embodiment, the casing 200 may include a coating that encapsulates the external thread 220. The coating may include at least one material selected from the group consisting of polycrystalline diamond particles, tungsten carbide, boron nitride, silicon carbide, silicon nitride, and combinations thereof. In some embodiments, the external thread 220 may be right handed or left handed, and may include one or more starts.

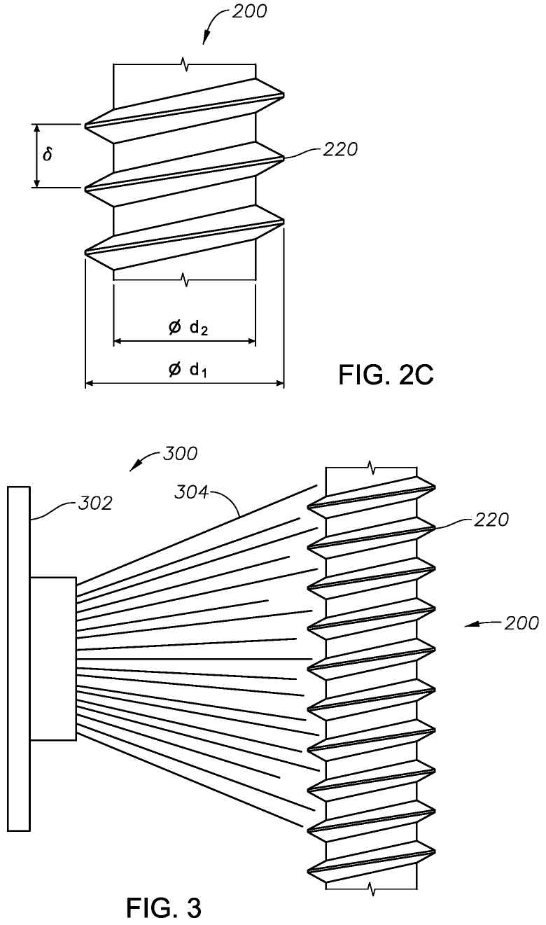

FIG. 3 illustrates an example method 300 for manufacturing a casing 200 for a drilling operation, according to one or more example embodiments of the disclosure. The method includes providing a casing 200 having body portion 204 having a length 206, a first end 208, and a second end 210. The casing also includes an outer diameter, an inner diameter, and a central axis that is common to the outer diameter and the inner diameter. The method 300 includes forming an external thread 220 on the outer diameter of the body portion 204, wherein the external thread starts 220 at a first predetermined distance from the first end 208 and ends at a second predetermined distance from the second end 210. The external thread 220 includes a spiral groove or a helical thread formed on the outer diameter of the body portion 204, may be right handed or left handed, and may include one or more starts.

The method 300 may also include providing a coating 304 that at least partially encapsulates the external thread 220. The coating 304 includes at least one material selected from the group consisting of polycrystalline diamond particles, tungsten carbide, boron nitride, silicon carbide, silicon nitride, and combinations thereof. In this example embodiment, the coating 304 is deposited by physical vapor deposition, chemical vapor deposition, plasma spraying, atomic layer deposition, or combinations thereof. In one example embodiment, the coating 304 may further includes nano particles comprising tungsten carbide or diamond. Tungsten carbide is a dense, metallike substance, light gray with a bluish tinge that decomposes, rather than melts, at 2,600° C. (4,700° F.). It is prepared by heating powdered tungsten with carbon black in the presence of hydrogen at 1,400°-1,600° C. (2,550°-2,900° F.). As it may be apparent to one of skill in the art, the coating 304 may partially or fully encapsulate external threading 220.

Physical vapor deposition (PVD), sometimes (especially in single-crystal growth contexts) called physical vapor transport (PVT), describes a variety of vacuum deposition methods which can be used to produce thin films and coatings. PVD is characterized by a process in which the material goes from a condensed phase to a vapor phase and then back to a thin film condensed phase. The most common PVD processes are sputtering and evaporation.

Chemical vapor deposition (CVD) is a vacuum deposition method used to produce high quality, high-performance, solid materials. In typical CVD, the wafer (substrate) is exposed to one or more volatile precursors, which react and/or decompose on the substrate surface to produce the desired deposit. Frequently, volatile by-products are also produced, which are removed by gas flow through the reaction chamber.

Microfabrication processes widely use CVD to deposit materials in various forms, including: monocrystalline, polycrystalline, amorphous, and epitaxial. These materials include: silicon (dioxide, carbide, nitride, oxynitride), carbon (fiber, nanofibers, nanotubes, diamond and graphene), fluorocarbons, filaments, tungsten, titanium nitride and various high-k dielectrics.

In plasma spraying process, the material to be deposited (feedstock), typically as a powder, sometimes as a liquid, suspension, or wire, is introduced into the plasma jet, emanating from a plasma torch. In the jet, where the temperature is on the order of 10,000 K, the material is melted and propelled towards a substrate. There, the molten droplets flatten, rapidly solidify and form a deposit. Commonly, the deposits remain adherent to the substrate as coatings, free-standing parts can also be produced by removing the substrate. There are a large number of technological parameters that influence the interaction of the particles with the plasma jet and the substrate and therefore the deposit properties. These parameters include feedstock type, plasma gas composition and flow rate, energy input, torch offset distance, substrate cooling, etc.

Atomic layer deposition (ALD) is a thin-film deposition technique based on the sequential use of a gas phase chemical process; it is a subclass of chemical vapour deposition. The majority of ALD reactions use two chemicals called precursors (also called “reactants”). These precursors react with the surface of a material one at a time in a sequential, self-limiting, manner. Through the repeated exposure to separate precursors, a thin film is slowly deposited. ALD is a key process in the fabrication of semiconductor devices, and part of the set of tools available for the synthesis of nanomaterials.

The Specification, which includes the Summary, Brief Description of the Drawings and the Detailed Description, and the appended Claims refer to particular features (including process or method steps) of the disclosure. Those of skill in the art understand that the disclosure includes all possible combinations and uses of particular features described in the Specification. Those of skill in the art understand that the disclosure is not limited to or by the description of embodiments given in the Specification.

Those of skill in the art also understand that the terminology used for describing particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this disclosure belongs unless defined otherwise.

As used in the Specification and appended Claims, the singular forms “a,” “an,” and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The devices and methods described herein, therefore, are well adapted to carry out the objects and attain the ends and advantages mentioned, as well as others inherent therein. While example embodiments of the device and method have been given for purposes of disclosure, numerous changes exist in the details of procedures for accomplishing the desired results. These and other similar modifications may readily suggest themselves to those skilled in the art, and are intended to be encompassed within the spirit of the device and method disclosed herein and the scope of the appended claims.

1. A casing for a drilling operation, the casing comprising:
a body portion having a length, a first end and a second end, an outer diameter, an inner diameter, and a central axis that is common to the outer diameter and the inner diameter; and
an external thread formed on the outer diameter of the body portion, wherein the external thread starts at a first predetermined distance from the first end and ends at a second predetermined distance from the second end.

2. The casing of claim 1, wherein the external thread comprises a spiral groove or a helical thread formed on the outer diameter of the body portion.

3. The casing of claim 1, wherein the external thread is formed at an angle ranging from about 1 degree to 45 degrees.

4. The casing of claim 1, wherein the external thread protrudes from the casing about 0.25 to 2.0 inches.

5. The casing of claim 1, wherein the casing comprises a coating at least partially encapsulating the external thread, wherein the coating comprises at least one material selected from the group consisting of polycrystalline diamond particles, diamond like carbon (DLC), tungsten carbide, boron nitride, silicon carbide, silicon nitride, and combinations thereof.

6. The casing of claim 5, wherein the coating is deposited by physical vapor deposition, chemical vapor deposition, plasma spraying, atomic layer deposition, or combinations thereof.

7. The casing of claim 5, wherein the coating further comprises nano particles comprising tungsten carbide or diamond.

8. The casing of claim 1, wherein the external thread is formed at least 200 feet behind a drill bit of a bottom hole assembly to which the casing is attached.

9. The casing of claim 1, wherein the casing is suitable for operation in a straight hole or a directional hole.

10. The casing of claim 1, wherein the casing is hydro-formed, spray metal, or carbon fiber reinforced.

11. The casing of claim 1, wherein the external thread is right handed or left handed.

12. The casing of claim 1, wherein the external thread comprises one or more starts.

13. A method of forming a casing for a drilling operation, the method comprising:
providing a body portion having a length, a first end and a second end, an outer diameter, an inner diameter, and a central axis that is common to the outer diameter and the inner diameter; and
forming an external thread on the outer diameter of the body portion, wherein the external thread starts at a first predetermined distance from the first end and ends at a second predetermined distance from the second end.

14. The method of claim 13, wherein the external thread comprises a spiral groove or a helical thread formed on the outer diameter of the body portion.

15. The method of claim 13, wherein the external thread is formed at an angle ranging from about 1 degree to 45 degrees.

16. The method of claim 13, wherein the external thread protrudes from the casing about 0.25 to 2.0 inches.

17. The method of claim 13, further comprising:
providing a coating that at least partially encapsulates the external thread, wherein the coating comprises at least one material selected from the group consisting of polycrystalline diamond particles, diamond like carbon (DLC), tungsten carbide, boron nitride, silicon carbide, silicon nitride, and combinations thereof.

18. The method of claim 17, wherein the coating is deposited by physical vapor deposition, chemical vapor deposition, plasma spraying, atomic layer deposition, or combinations thereof.

19. The method of claim 17, wherein the coating further comprises nano particles comprising tungsten carbide or diamond.

20. The method of claim 13, wherein the external thread is formed at least 200 feet behind a drill bit of a bottom hole assembly to which the casing is attached.
